(19) United States
(12) Patent Application Publication
(10) Pub. No.: US 2024/0149228 A1
(43) Pub. Date: May 9, 2024

(54) STATIC MIXER

(71) Applicants: EVAN SCHNEIDER, PIEDMONT, CA (US); ALEXANDER MITCHELL, ST HELENA, CA (US)

(72) Inventors: EVAN SCHNEIDER, PIEDMONT, CA (US); ALEXANDER MITCHELL, ST HELENA, CA (US)

(21) Appl. No.: 18/387,499

(22) Filed: Nov. 7, 2023

Related U.S. Application Data
(63) Continuation-in-part of application No. 29/859,135, filed on Nov. 8, 2022.
(60) Provisional application No. 63/423,504, filed on Nov. 8, 2022.

(51) Int. Cl. B01F 25/312; B01F 23/236; B01F 23/237; B01F 25/4314

(52) U.S. Cl. CPC B01F 25/3121; B01F 23/236; B01F 23/237611; B01F 25/31242; B01F 25/4314; B01F 2101/16

(57) ABSTRACT

A device for introducing and entraining a second fluid into a first fluid includes a Venturi device, an output tube, and a static mixer. The static mixer is shaped and dimensioned to slide and fit into the output tube and the output tube with the inserted static mixer is removably attached to an output end of the Venturi device. The static mixer includes a tubular component having an integrated gasket at a first end and fins extending radially from an inner surface of the tubular component and twisting around a central axis of the tubular component.

### CROSS REFERENCE TO RELATED CO-PENDING APPLICATIONS

This application claims the benefit of U.S. provisional application Ser. No. 63/423,504 filed Nov. 8, 2022 and entitled “STATIC MIXER”, the contents of which are expressly incorporated herein by reference.

This application claims the benefit of U.S. patent application Ser. No. 29/859,135 filed Nov. 8, 2022 and entitled “STATIC MIXER”, the contents of which are expressly incorporated herein by reference.

### FIELD OF THE INVENTION

The present invention relates to a static mixer for entraining fluids and in particular to a static mixer that can be used at the output of a Venturi device in order to improve the mixing of the fluids.

### BACKGROUND OF THE INVENTION

The effect of oxygen in wines is usually considered to be detrimental to their quality, and therefore exposure of wines to oxygen is in general to be avoided. However, there are some cases when the introduction of air or oxygen, (or other gases or liquids) into wine is desirable. One of such cases is during the process of fermentation. Controlled mixing of air or oxygen into the must during fermentation has been found to be beneficial to the fermentation process and the flavor of the wine.

One method of introducing air or oxygen into the must is using a combination of a pump-over mechanism with an in-line Venturi device. One example of a pump-over mechanism is described in U.S. patent application Ser. No. 14/478,269 filed Sep. 5, 2014 and entitled “WINE PUMP-OVER DEVICE”, the contents of which are expressly incorporated herein by reference. A Venturi device 90 utilizes the Venturi effect, whereby the pressure of a primary fluid 84 (i.e., wine) flowing through a pipe is reduced when the fluid passes through a constricted section of the pipe. The low pressure zone within the constricted section causes a secondary fluid 82 (i.e., air) to be pulled into the pipe and become entrained and mixed with the stream of the fluid 86, as shown in FIG. 1.

As the mixed fluids 86 exit the Venturi, it is sometimes the case that the working fluid 84 (i.e., wine) doesn't mix well with the additional fluid 82 (i.e., air), and instead forms a “firehose” stream of wine 86a, surrounded by air 86b. Although these fluids 86a, 86b have a chance to mix downstream in the bends and curves of any plumbing that may follow the Venturi, such mixing is often not high-quality or repeatable as setups change. Additionally, the potential formation of an unobstructed air connection between the secondary fluid inlet on the Venturi and the ultimate outlet of the Venturi can act to break the vacuum, and interrupt the Venturi functionality. Therefore, it is desirable to provide additional mixing of the fluids 86a, 86b at the Venturi output.

### SUMMARY OF THE INVENTION

The present invention relates to a static mixer that can be used at the output of a Venturi device in order to improve the mixing of the fluids. The static mixer includes sloped twisted inner fins that gently mix the fluids, and an open center that permits use of whole-berry fermentation without clogging.

In general, in one aspect, the invention features a device for introducing and entraining a second fluid into a first fluid including a Venturi device, an output tube, and a static mixer. The static mixer is shaped and dimensioned to slide and fit into the output tube and the output tube with the inserted static mixer is removably attached to an output end of the Venturi device.

Implementations of this aspect of the invention include one or more of the following. The device further includes a clamp and the output tube with the inserted static mixer is removably attached to the output end of the Venturi device with the clamp. The static mixer includes an open center and sloped twisted inner fins that gently mix the fluids.

The static mixer comprises a tubular component having an integrated gasket at a first end and fins extending radially from an inner surface of the tubular component and twisting around a central axis of the tubular component. The integrated gasket of the static mixer is shaped and dimensioned to fit into a groove formed on an output end of the Venturi device. The integrated gasket includes rubber over-molds formed over a rigid core edge of the first end of the tubular component. Each fin has a triangular shape having a first side surface attached to the inner surface of the tubular component, a second side surface perpendicular to the first side surface and a third side surface that forms a hypotenuse of an orthogonal triangle formed by the first and second side surfaces. The second and third side surfaces are curved and slopped. The fins form a 45° degree “twist” relative to the central axis. The inner side of the first end of the tubular component has a 45° degree chamfer that provides a nearly seamless lead-in transition of the first and second fluids into the static mixer. The static mixer includes one of polymer materials, plastic materials, ceramic, composite, stainless steel, cast steel, non-corrosive metal or alloy, or semi-rigid plastic. The over-molds includes soft compliant material.

The first and second fluids are a liquid or a gas. The first and second fluids include one of wine, cider, tea, coffee, probiotic liquids, water, air, oxygen, gasoline, food additives or small berries.

In general, in another aspect, the invention features a device for entraining a second fluid into a first fluid including a static mixer that is shaped and dimensioned to slide and fit into an output tube and the output tube with the inserted static mixer is removably attached to an output end of a Venturi device. The static mixer comprises a tubular component having an integrated gasket at a first end and fins extending radially from an inner surface of the tubular component and twisting around a central axis of the tubular component.

In general, in another aspect, the invention feature a method for introducing and entraining a second fluid into a first fluid including providing a Venturi device, providing a static mixer and an output tube, sliding the static mixer into the output tube, inserting and removably attaching the output tube with the inserted static mixer to an output end of the Venturi device, introducing the first fluid into a converging component of the Venturi device, drawing the second fluid into the Venturi component, mixing the second fluid with the first fluid in an inner section of the Venturi device thereby forming a mixed fluid, and flowing the mixed fluid through a diverging component of the Venturi device and exiting the mixed fluid through the static mixer into the output tube.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 depicts a Venturi device used to mix wine (primary fluid) with air (secondary fluid);

FIG. 2 depicts a static mixer according to this invention used at the output of the Venturi device of FIG. 1;

FIG. 3 is a front perspective view of the static mixer of FIG. 2;

FIG. 4 is a front elevational view of the static mixer of FIG. 2;

FIG. 5 is a back perspective view of the static mixer of FIG. 2;

FIG. 6 is a side elevational view of the static mixer of FIG. 2;

FIG. 7A is a side perspective view of the static mixer of FIG. 2; and

FIG. 7B is a cross-sectional view of the static mixer of FIG. 6, along the X-Z plane.

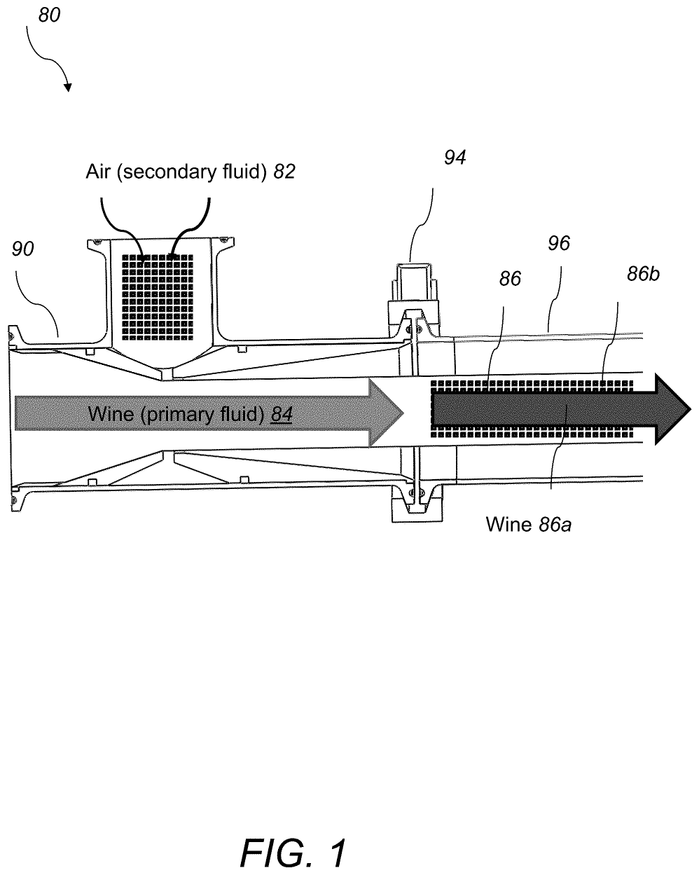

### DETAILED DESCRIPTION OF THE INVENTION

The present invention provides a static mixer for entraining fluids and in particular to a static mixer that is used at the output of a Venturi device in order to improve the mixing of the fluids.

As was mentioned above, in some cases the primary working fluid 84 (i.e., wine) doesn't mix well with the additional fluid 82 (i.e., air) at the output of the Venturi, and instead forms a “firehose” stream of wine 86a, surrounded by air 86b. Although these fluids have a chance to mix downstream in the bends and curves of any plumbing that may follow the Venturi, such mixing is often not high-quality or repeatable as setups change. Additionally, the potential formation of an unobstructed air connection between the secondary fluid inlet on the Venturi and the ultimate outlet of the Venturi could break the vacuum, and interrupt Venturi functionality. Mixing the primary working fluid 84 with the secondary fluid 82 post-venturi can improve both of these problems. However all such “static mixing” devices on the market today are difficult to install, and not optimized for a low-backpressure system.

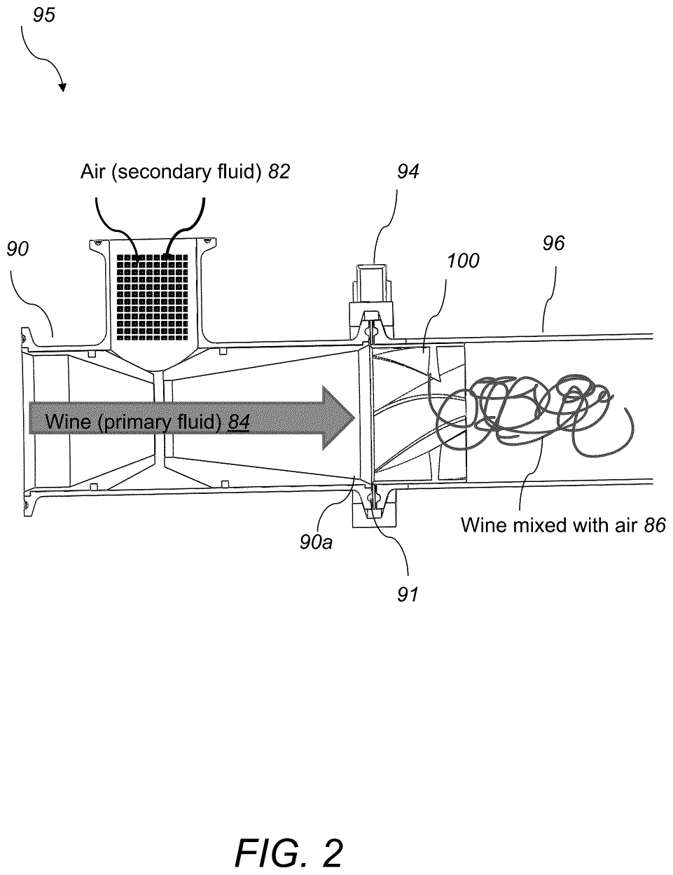

Referring to FIG. 2, a Venturi system 95 according to this invention includes a Venturi device 90, an output tube 96, a static mixer 100, and a clamp 94. The static mixer 100 is shaped and dimensioned to slide and fit into the output tube 96 and the output tube 96 with the inserted static mixer 100 is clamped to the output end 90a of the Venturi device 90 with the clamp 94. Static mixer 100 mixes the primary fluid 84 flow with the secondary fluid 82 flow by introducing turbulence into their combined fluid 86 flow. The static mixer 100 is shaped and dimensioned so that any backpressure that is created is minimized.

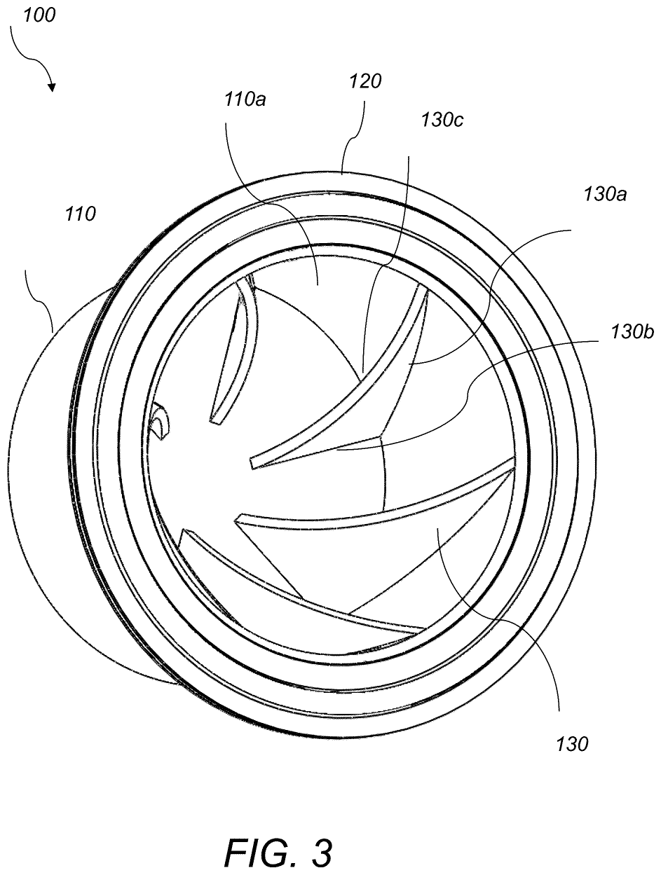

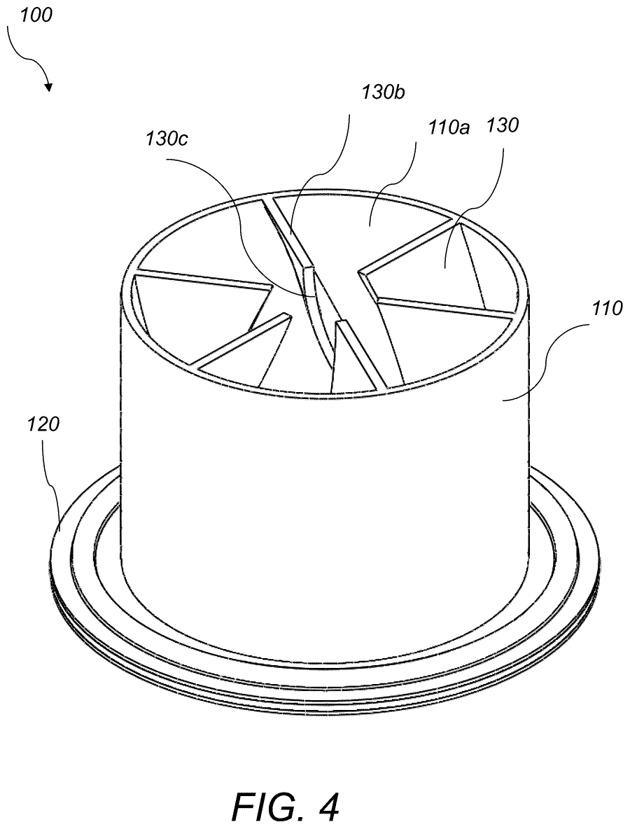

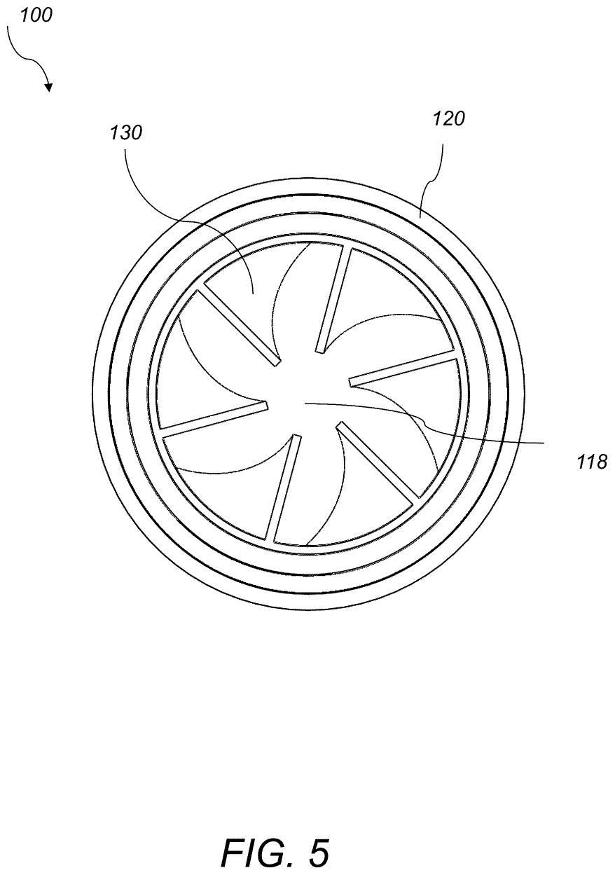

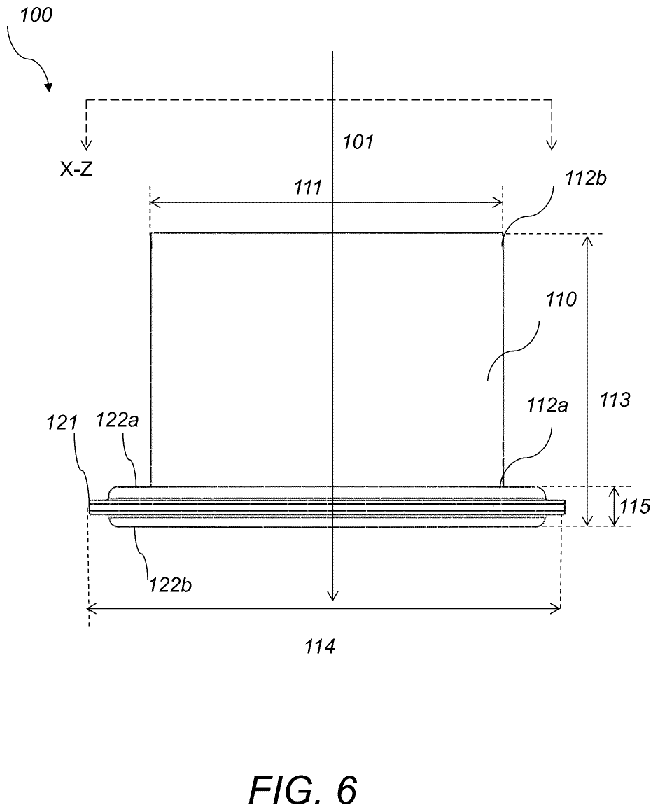

Referring to FIG. 3-FIG. 7B, static mixer 100 includes a tubular component 110 having an integrated gasket 120 at a first end 112a and six evenly spaced fins 130 extending radially from an inner surface 110a of the tubular component 110 and twisting around the central axis 101. The static mixer 100 is inserted into the output tube 96 so that the integrated gasket 120 protrudes from a first end of the output tube 96, and attaches to the output end 90a of the Venturi device 90 by inserting the gasket 120 of the static mixer 100 into a groove 91 formed on the output end 90a of the Venturi device 90. Once assembled, the Venturi device 90 and the output tube 96 with the inserted static mixer 100 are clamped together with clamp 94. The integrated gasket 120 includes rubber over-molds 122a, 122b formed over a rigid core edge 121 of the first end 112a of the tubular component 110, shown in FIG. 6.

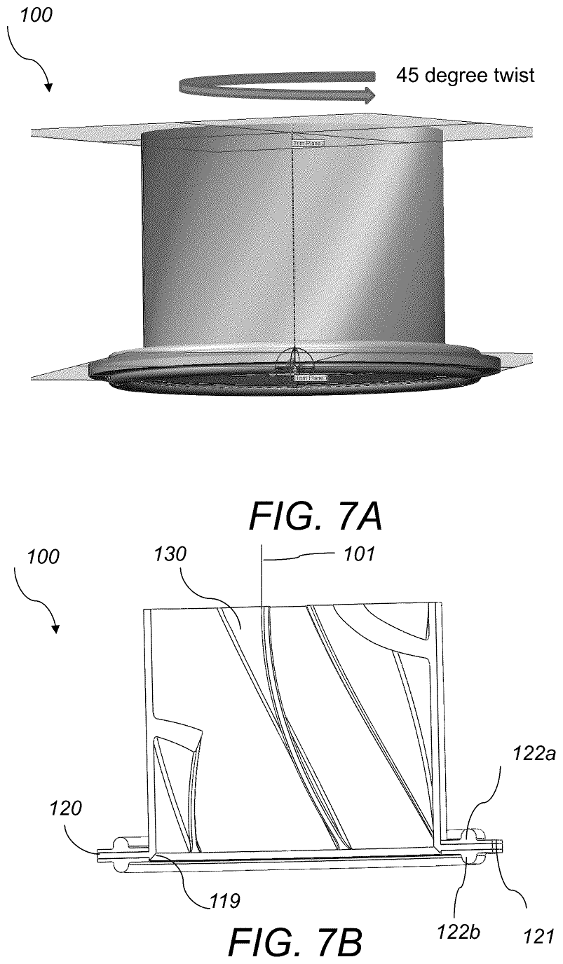

In one example, a static mixer 100 is designed to be inserted into a 2″ inch diameter outer tube 96 and has an outer diameter 111 of 1.864″ inches, and a length 113 of 1.559″ inches. The integrated gasket 120 has an outer diameter 114 of 0.2516″ inches and a thickness 115 of 0.208″ inches. A center through opening 118 has a diameter of 0.5″ inch and is dimensioned to allow whole berries to pass through. Each fin 130 has a triangular shape having a first side surface 130a attached to the inner surface 110a of the tubular component 110, a second side surface 130b perpendicular to the first side surface 130a and a third side surface 130c that forms the hypotenuse of the orthogonal triangle 130. The unattached side surfaces 130b, 130c are curved and slopped so that the fin forms a 45° degree “twist” relative to the central axis 101, as shown in FIG. 7A and FIG. 7B. These “twisted” fins 130 introduce a gentle mixing motion to the primary and secondary fluids. The inner side 119 of the first end 112a of the tubular component 110 has a 45° degree chamfer that provides a nearly seamless lead-in transition of the fluids 84, 82, 86 into the mixer 100. The mixer 100 may be made out of polymer materials, plastic materials, ceramic, composite, stainless steel, cast steel, any other non-corrosive metal or alloy, or semi-rigid plastic, such as Polypropylene Impact Copolymer Moplen EP332L manufactured by LyondellBasell Industries. The over-molded gasket 120 may be made of soft compliant material such as Viton™. The static mixer 100 may be used for any type of liquid or gas including wine, cider, tea, coffee, probiotic liquids, water, air, oxygen, gasoline, food additives and small berries, among others.

Advantages of the invention include one or more of the following. The static mixer 100 gently “teases” the combined fluid 86 exiting a Venturi (or other systems) by running it through the twisted fins 130, which end in a linear slope. This geometric structure of the twisted fins 130 ensures good contact and mechanical interaction with the working fluid 84, without materially impacting the cross sectional area through which the working fluid can flow. Furthermore, the twisted fins 130 move the working fluid 84 sufficiently to block any continuous channel of secondary fluid 82 between the Venturi inlet and the outlet of the system, without causing an extraordinary amount of interruption to flow, which would in turn could cause large backpressure and adversely affect Venturi or upstream device performance.

The static mixer 100 can be used without needing extra space or modification of the existing components. Because the mixer 100 fits into the output tubing 96, and has an integrated gasket 120 as part of the device, no additional modification is needed to incorporate them into an existing pump-over or fluid mixing system. The static mixer 100 resists clogging due to the constantly sloped fins 130 and the open center 118. The sloped fins 130 gently mix the fluids, and the open center 118 permits use of whole-berry fermentation that quickly clogs other mixers. The single-piece, accessible geometry of the mixer allows for frequent and complete cleaning in food-production environment.

Several embodiments of the present invention have been described. Nevertheless, it will be understood that various modifications may be made without departing from the spirit and scope of the invention. Accordingly, other embodiments are within the scope of the following claims.

What is claimed is:

1. A device for introducing and entraining a second fluid into a first fluid comprising:
a Venturi device;
an output tube;
a static mixer; and
wherein the static mixer is shaped and dimensioned to slide and fit into the output tube and the output tube with the inserted static mixer is removably attached to an output end of the Venturi device.

2. The device of claim 1, further comprising a clamp and the output tube with the inserted static mixer is removably attached to the output end of the Venturi device with the clamp.

3. The device of claim 1, wherein the static mixer comprises an open center and sloped twisted inner fins that gently mix the fluids.

4. The device of claim 1, wherein the static mixer comprises a tubular component having an integrated gasket at a first end and fins extending radially from an inner surface of the tubular component and twisting around a central axis of the tubular component.

5. The device of claim 4, wherein the integrated gasket of the static mixer is shaped and dimensioned to fit into a groove formed on an output end of the Venturi device.

6. The device of claim 4, wherein the integrated gasket comprises rubber over-molds formed over a rigid core edge of the first end of the tubular component.

7. The device of claim 4, wherein each fin has a triangular shape having a first side surface attached to the inner surface of the tubular component, a second side surface perpendicular to the first side surface and a third side surface that forms a hypotenuse of an orthogonal triangle formed by the first and second side surfaces.

8. The device of claim 7, wherein the second and third side surfaces are curved and slopped.

9. The device of claim 4, wherein the fins form a 45° degree “twist” relative to the central axis.

10. The device of claim 4, wherein the inner side of the first end of the tubular component has a 45° degree chamfer that provides a nearly seamless lead-in transition of the first and second fluids into the static mixer.

11. The device of claim 1, wherein the static mixer comprises one of polymer materials, plastic materials, ceramic, composite, stainless steel, cast steel, non-corrosive metal or alloy, or semi-rigid plastic.

12. The device of claim 6, wherein the over-molds comprises soft compliant material.

13. The device of claim 1, wherein the first and second fluids comprise a liquid or a gas.

14. The device of claim 1, wherein the first and second fluids comprise one of wine, cider, tea, coffee, probiotic liquids, water, air, oxygen, gasoline, food additives or small berries.

15. A device for entraining a second fluid into a first fluid comprising:
a static mixer;
wherein the static mixer is shaped and dimensioned to slide and fit into an output tube and the output tube with the inserted static mixer is removably attached to an output end of a Venturi device; and
wherein the static mixer comprises a tubular component having an integrated gasket at a first end and fins extending radially from an inner surface of the tubular component and twisting around a central axis of the tubular component.

16. A method for introducing and entraining a second fluid into a first fluid comprising:
providing a Venturi device;
providing a static mixer and an output tube;
sliding the static mixer into the output tube, inserting and removably attaching the output tube with the inserted static mixer to an output end of the Venturi device;
introducing the first fluid into a converging component of the Venturi device;
drawing the second fluid into the Venturi component, and mixing the second fluid with the first fluid in an inner section of the Venturi device thereby forming a mixed fluid; and
flowing the mixed fluid through a diverging component of the Venturi device and exiting the mixed fluid through the static mixer into the output tube.

17. The method of claim 16 wherein the static mixer comprises a tubular component having an integrated gasket at a first end and fins extending radially from an inner surface of the tubular component and twisting around a central axis of the tubular component.

18. The method of claim 16, wherein the first and second fluids comprise one of wine, cider, tea, coffee, probiotic liquids, water, air, oxygen, gasoline, food additives or small berries.
